(19) United States
(12) Patent Application Publication
(10) Pub. No.: US 2017/0148291 A1
(43) Pub. Date: May 25, 2017

(54) METHOD AND A SYSTEM FOR DYNAMIC DISPLAY OF SURVEILLANCE FEEDS

(71) Applicant: HITACHI, LTD., Tokyo (JP)

(72) Inventor: Shubhranshu BARNWAL, Bangalore (IN)

(73) Assignee: HITACHI, LTD., Tokyo (JP)

(21) Appl. No.: 15/352,830

(22) Filed: Nov. 16, 2016

(30) Foreign Application Priority Data
Nov. 20, 2015 (IN) 6268/CHE/2015

(51) Int. Cl. G08B 13/196; G06K 9/00; H04N 7/18

(52) U.S. Cl. CPC G08B 13/19678; G08B 13/19645; G08B 13/19613; H04N 7/181; G06K 9/00771

(57) ABSTRACT

The present disclosure discloses a method and a device for dynamically displaying one or more surveillance feeds. The method comprises receiving surveillance feeds and surveillance data, determining for each of the surveillance feeds, a confidence score for each of predefined classes. Here, each of the predefined classes is grouped under one of one or more predefined categories. The method further comprises determining importance score for each of the surveillance feeds based on the confidence score of each of the predefined classes of the corresponding surveillance feeds and determining a final score for each of the surveillance feeds based on the corresponding importance score and the surveillance data. The surveillance feeds are dynamically displayed based on the final score.

The following specification particularly describes the invention and the manner in which it is to be performed.

### TECHNICAL FIELD

The present disclosure relates in general to a surveillance system and more particularly but not exclusively to a system and a method of surveillance for identifying unknown activities and dynamically displaying one or more surveillance feeds based on priority.

### BACKGROUND

Video surveillance systems are used to monitor human behaviour for security purposes in offices, shops and malls, banks, prisons, juvenile facility, mental institution, infant monitoring and many other places. Such systems generally have large number of cameras with generally lesser number of screens or apparent screens, further having much lesser number of security personnel monitoring them. Let the number of cameras be denoted by ‘a’, number of screen be denoted by ‘b’ and number of security personnel monitoring the screen be denoted by ‘c’. Generally, the relation between a, b and c is given by: a≧b≧c, to keep hardware and employee costs down. Example can be a 1-1-1 system (1 camera being monitored on 1 screen watched by 1 watchman) or a 40-10-2 system (40 cameras being monitored on 10 screens (or 10 windows on 1 screen) watched by 2 watchmen). Hence, it is a tedious job of the security personnel to attend each of the video feeds in every monitor. Thus, these systems are prone to human errors although the system efficiency is high. Moreover, the existing systems display feeds that may not seek attention or intervention. Hence, there is a need for a system for displaying the important feeds on priority.

The surveillance systems exist both with and without the use of machine automation. Machine automation are able to increase efficiency and alertness level of security personnel by generating audio and/or visual alarms, for cameras that have movements (in more primitive automation), or for cameras that have a known abnormal behaviour (in more advanced automation), to the limited sets of screens present in the system. However, scheduling of multiple cameras on a limited number of screens based on varying factors of importance has been a challenging problem.

FIG. 1 of the present disclosure shows a graph illustrating how existing machine learning classifiers identify one or more activities in a surveillance feed. FIG. 1 shows a graph illustrating how typical classifiers identify multiclass categories. The conventional classifiers use “one-vs-all” method to identify each of the multiclass activity. Further, the graph discloses how a classifier classifies the one or more activities using binary classification method. Here, the classifier fails to identify those activities that are not predefined. Such activities are either classified under one of one or more predefined classes or may be ignored by the classifier. This leads to inappropriate mapping of data or loss of data.

### SUMMARY

Disclosed herein is the method and system for dynamically displaying one or more surveillance feeds. One or more surveillance feeds are gathered by a surveillance system and each of the one or more surveillance feeds are dynamically displayed based on priority. Also an is generated by the surveillance system to alert security personnel monitoring the one or more surveillance feeds.

Embodiments of the present disclosure relate to a method for dynamically displaying surveillance feeds the method comprising, receiving by a surveillance unit the one or more surveillance feeds and one or more surveillance data, determining for each of the one or more surveillance feeds, a confidence score for each of one or more predetermined classes, where each of the one or more predefined classes are grouped under one of one or more predefined categories. The method further comprising, determining importance score for each of the one or more surveillance feeds based on the confidence score of each of the one or more predefined classes of the corresponding one or more surveillance feeds and determining a final score for each of the one or more surveillance feeds based on the corresponding importance score and the one or more surveillance data.

In an embodiment, a surveillance unit for dynamically displaying surveillance feeds is disclosed. The surveillance unit comprises a processor and a memory communicatively coupled to the processor. The memory stores processor-executable instructions, which on execution causes the processor to receive one or more surveillance feeds and one or more surveillance data, determine for each of the one or more surveillance feeds, a confidence score for each of one or more predefined classes, where each of the one or more predefined classes are grouped under one of one or more predefined categories. The processor further determines importance score for each of the one or more surveillance feeds based on the confidence score of each of the one or more predefined classes of the corresponding one or more surveillance feeds and determines a final score for each if the one or more surveillance feeds based on the corresponding importance score of each of the one or more surveillance data.

In an embodiment, the present disclosure discloses a surveillance system to dynamically display one or more surveillance feeds. The system comprises one or more capturing units to capture one or more surveillance feeds, a surveillance unit to receive the one or more surveillance feeds and perform the method as described above and a notification unit to generate an alarm. The alarm is generated when one of the final score of each of the one or more surveillance feeds exceeds a predefined threshold value.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 shows a graph illustrating classification of surveillance feeds into categories using traditional classifiers;

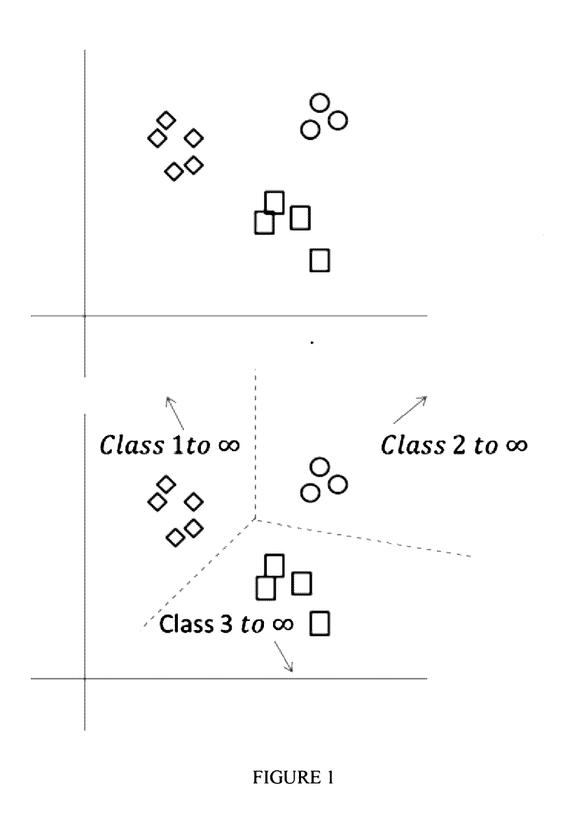

FIG. 2 illustrates an exemplary block diagram of a surveillance system in accordance with some embodiments of the present disclosure;

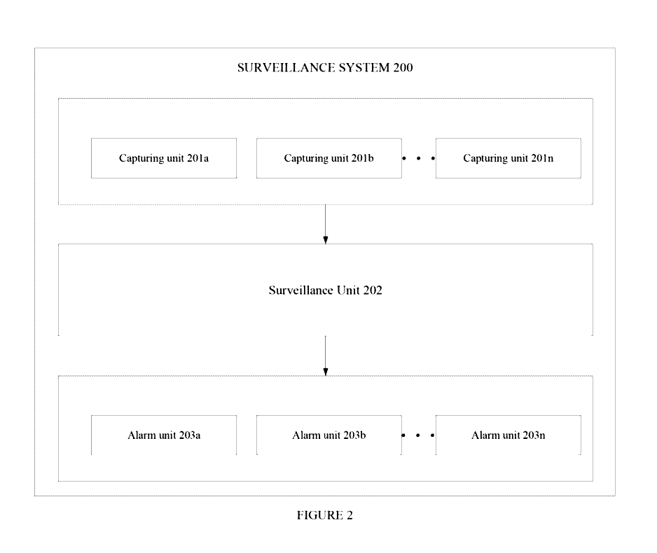

FIG. 3 shows an exemplary block diagram of a surveillance unit in accordance with some embodiments of the present disclosure;

FIG. 4 shows an exemplary graph for deriving importance score in accordance with some embodiments of the present disclosure;

FIG. 5 illustrates method flow chart for dynamically displaying surveillance feeds in accordance with some embodiments of the present disclosure; and

FIG. 6 shows an exemplary block diagram illustrating the working of a general computer system in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In an embodiment, the present disclosure discloses a surveillance system for dynamically displaying one or more surveillance feeds. The surveillance system receives one or more surveillance feeds from one or more capturing devices. Further, the surveillance device comprises a surveillance unit to process the captured one or more surveillance feeds and dynamically displays the one or more feeds. The dynamic display of the one or more surveillance feeds prioritizes the important surveillance feeds, thereby increasing surveillance intelligence. Also, the surveillance system may comprise an alarm unit to alert security personnel monitoring the one or more surveillance feeds, thus reducing human errors while monitoring. Figure discloses a surveillance system 200 for dynamically displaying one or more surveillance feeds. The surveillance system 200 comprises one or more capturing units 201a, 201b, . . . , 201n (collectively referred to as 201), surveillance unit 202 and one or more alarm units 203a, 203b, . . . , 203n (collectively referred to as 203). The one or more capturing units 201 may be any device that captures one or more activities. The one or more capturing units 201 can be a device to capture at least one of, one or more audio feeds, one or more video feeds and one or more other feeds. The surveillance unit 202 receives the one or more surveillance feeds from the one or more capturing units 201 and processes the data. The surveillance unit 202 outputs a final score, based on which an appropriate action is performed by the display unit and one or more alarm units 203. The display unit displays the one or more surveillance feeds based on the final score of each of the one or more surveillance feeds determined by the surveillance unit 202. Further, the one or more alarm units 203 generates alarm notification when the final score of at least one of, each of the one or more surveillance feeds is greater than a predefined threshold value. The alarm generated maybe a vibration alarm, visual alarm or an audio alarm.

In an embodiment, the one or more capturing units 201 may be associated with the surveillance unit 202 through wired or wireless networks. In an exemplary embodiment, the one or more other feeds may comprise infrared feeds, ultrasound feeds etc.

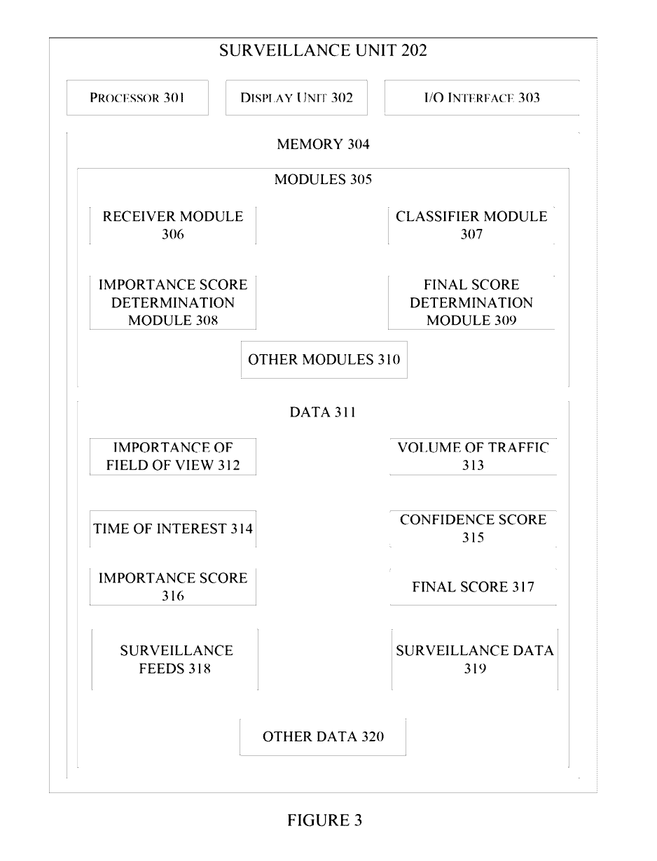

One embodiment of the present disclosure relates to a surveillance unit 202 for dynamically displaying one or more surveillance feeds 318. FIG. 3 of the present disclosure shows an exemplary block diagram of a surveillance unit 202. The surveillance unit 202 comprises a processor 301 and a memory 304 communicatively coupled to the processor 301. The memory 304 stores processor-executable instructions, which, on execution, cause the processor 301 to receive the one or more surveillance feeds 318 and one or more surveillance data 319. Further, the processor 301 determines, for each of the surveillance feeds 318, a confidence score 315 for each of one or more predefined classes. Here, each of the one or more predefined classes is grouped under one of one or more predefined categories. Furthermore, the processor 301 determines an importance score 316 for each of the one or more surveillance feeds 318 based on the confidence score 315 of each of the one or more predefined classes of the corresponding one or more surveillance feeds. Lastly, the processor 301 determines a final score 317 for each of the one or more surveillance feeds 318 based on the corresponding importance score 316 and the one or more surveillance data 319. The one or more surveillance feeds 318 are then dynamically displayed by a display unit 302 based on the final score 317 of each of the one or more surveillance feeds 318.

In an embodiment, one or more data 311 may be stored within the memory 304. The one or more data 311 may include, for example, importance of field of view 312, volume of traffic 313, time of interest 314, confidence score 315, importance score 316, final score 317, one or more surveillance feeds 318, one or more surveillance data 319 and other data 320. The one or more data 311 are input to the surveillance unit 202 which is used to determine the final score for each of the one or more surveillance feeds.

In an embodiment, the importance of field of view 312 is input to the surveillance unit 202 by a user. The importance of field of view 312 of one or more capturing devices mainly depends on the location of the one or more capturing devices.

In an embodiment, volume of traffic 313 determines the number of subjects moving within the field of view of the one or more capturing devices.

In an embodiment, time of interest 314 is input to the surveillance unit 202. The time of interest 314 may be time of day and day of a week. This parameter illustrates time at which the traffic has to be monitored with priority. All the three data 311 inputs, along with importance score 316 of each of the one or more surveillance feeds 318 are used to calculate the final score 317 of each of the surveillance feeds 318. The other data 320 may be used to store data, including temporary data and temporary files, generated by one or more modules 305 for performing the various functions of surveillance unit 202.

In an embodiment, the one or more data 311 in the memory 304 are processed by one or more modules 305 of the processor 301. The one or more modules 305 may be stored within the memory 304. In an example, the one or more modules 305, communicatively coupled to the processor 301, may also be present outside the memory 304. As used herein, the term module refers to an application specific integrated circuit (ASIC), an electronic circuit, a processor 301 (shared, dedicated, or group) and memory 304 that execute one or more software or firmware programs, a combinational logic circuit, and/or other suitable components that provide the described functionality.

In one implementation, the one or more modules 305 may include, for example, receiver module 306, classifier module 307, importance score determination module 308, final score determination module 309 and other modules 310.

In one embodiment, the receiver module 306 receives one or more surveillance feeds 318 from one or more capturing units 201 associated with the surveillance unit 202. The receiver module 306 converts the one or more surveillance feeds 318 into image frames. For example, one surveillance feed 318 may be converted to plurality of image frames. Thus, each of the one or more surveillance feeds 318 is converted to image frames resulting in “n” number of image frames. Further, each of the “n” image frames is converted to feature vector for further processing.

In one embodiment, the classifier module 307 classifies each of the one or more surveillance feeds 318 into one or more predefined classes. In one embodiment, the one or more classes are predefined based on the location to be monitored. Each of the one or more classes is grouped under one of one or more categories. The one or more categories are predefined and may be at least one of known wanted activity, known unwanted activity and unknown activity. In an embodiment, the one or more classes may be each one or more activities portrayed by a subject at a predefined interval of time. The classifier module 307 uses conventional machine learning algorithms along with modified algorithms to classify the one or more surveillance feeds 318. The classifier module 307 receives the feature vectors from the receiver module 306 and outputs a confidence score 315 for each of the predefined classes, for each of the one or more surveillance feeds 318. Based on the confidence score 315, each of the one or more surveillance feeds 318 is categorized under one of the one or more categories.

In an embodiment, the proposed machine learning algorithm may include, but is not limited to, Support Vector Machine (SVM), Hidden Markov Models (HMM), Neural Networks, etc., or include new or modified algorithm including statistical or machine learning models. The proposed hybrid model in the present disclosure comprehend Euclidean hyperspace and helps in capturing temporal features of the one or more subjects in the one or more surveillance feeds. Thus, the hybrid model assists in categorizing unknown activities of the one or more subjects into “unknown category”. The hybrid model classifies each of the one or more surveillance feeds 318 into different categories. In an exemplary embodiment, the present disclosure uses HMM as the hybrid model. Therefore, using HMM the unknown category is determined. Further, the present disclosure categorizes each of the one or more surveillance feeds 318 into one of the one or more predefined categories. The one or more surveillance feeds 318 not falling into any of the one or more categories are categorized under unknown category. HMM is an automatic iterative learning algorithm, which adjusts the parameters to a given predefined training sequence. Based on distance between two HMMs, the unknown category is determined. The distance between two HMMs for at least one feature vector of the one or more surveillance feeds is calculated as follows:

$$D ( {HMM}_{1} , {HMM}_{2} ) = \frac{1}{T} \times [ log P ( {Obs}_{2} \vert {HMM}_{2} ) - log P ( {Obs}_{2} \vert {HMM}_{1} ) ]$$

$$D ( {HMM}_{1} , {HMM}_{2} ) \neq D ( {HMM}_{2} , {HMM}_{1} )$$

$${D}_{sym} ( {HMM}_{1} , {HMM}_{2} ) = \frac{1}{2} ( D ( {HMM}_{1} , {HMM}_{2} ) + D ( {HMM}_{2} , {HMM}_{1} ) )$$

$${D}_{avg} ( {C}_{1} , {C}_{2} ) = \frac{\sum {\sum }_{{T}_{i} ∈ {C}_{1 ,} {T}_{j} ∈ {C}_{2}} {D}_{sym} ( {T}_{i} , {T}_{j} )}{\# {C}_{1} \# {C}_{2}}$$

$${D}_{avg} ( {T}_{test} , {C}_{1} ) = \frac{\sum {\sum }_{{T}_{i} ∈ {C}_{1}} {D}_{sym} ( {T}_{test} , {T}_{i} )}{\# {C}_{1}} \geq Max + Threshold$$

Where,

D=Distance of Hmm of observation 1 from HMM of observation 2;

T=Length of sequence measurements taken from the surveillance feed used for training the HMM;

Obs2=Sequence measurement used to train HMM2;

P(obs2|HMM2) expresses the probability of observing the sequence with HMM2;

P(obs2|HMM1) expresses the probability of observing the sequence with HMM1;

D_{sym}=Symmetric distance between HMMs of class 1 and 2;

D_{avg}=Average distance between HMMs of Trajectories of Class 1 and Class2;

Ti and Tj=Trajectories; and

C1 and C2=Predefined classes of the one or more surveillance feeds.

Based on the training sequence input to the HMM, a reference value is determined for each of the one or more known categories. From the above equations, a surveillance feed 218 is categorized as known wanted, known unwanted when the distances are less than a predetermined threshold and unknown, when the distance of that surveillance feed 318 is greater than a predetermined threshold value from the reference value of the rest of the one or more categories.

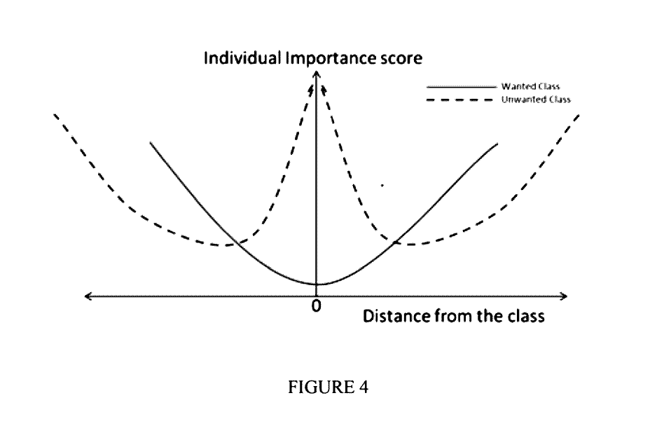

In an embodiment, the importance score determination module 308 determines the importance score 316 for each of the one or more surveillance feeds 318. The importance score 316 is determined based on the confidence score 315 of each of the one or more predefined classes of the corresponding one or more surveillance feeds 318. The importance score 316 curve may be as shown in FIG. 4. For example, when the HMM distance of the one or more surveillance feeds 318 are closer to the one or more predefined classes of known wanted category, the importance score 316 is low. However, when the HMM distance of the one or more surveillance feeds 318 moves away from the known wanted category, the importance score 316 increases. Once the HMM distance of the one or more surveillance feeds 318 exceeds the threshold value of distance, the importance score 316 is maximum. Likewise, when the HMM distance of the one or more surveillance feeds 318 are closer to the one or more classes of known unwanted category, the importance score 316 is high. When the HMM distance of the one or more surveillance feeds 318 move farther away from the known unwanted category, the importance score 316 begins to decrease. However, when the HMM distance of the one or more surveillance feeds 318 moves towards the unknown category, the importance score 316 increases and the importance score 316 is maximum once the one or more surveillance feeds 318 enters the unknown category.

The equations illustrating the exemplary curve showing the change in the importance score with distance of the class from one another is given below.

The equations for wanted class are given by:

dy/dx>0; d²y/dx²<=0 for 0<x<tw

dy/dx>0; d²y/dx²<0 for x>tw

dy/dx<0; d²y/dx²<=0 for −tw<x<0

dy/dx<0; d²y/dx²>0 for x<−tw

The equations to traverse a curve for wanted class are given by:

y=ax² for |x|<tw

y=log|bx| for |x|>tw

The equations for unwanted class are given by:

dy/dx<0; d²y/dx²<=0 for 0<x<tu

dy/dx>0d²y/dx²<0 for x>tu

dy/dx>0; d²y/dx²<=0 for −tu<x<0

dy/dx<0; d²y/dx²>0 for x<−tu

The equations to traverse a curve for unwanted class are given by:

y=1/|cx| for |x|<tu

y=log|dx| for |x|>tu

The notations used in the above equations are explained as follows:

y=Individual importance score;

x=Distance from the class;

tw=Threshold for wanted class;

tu=Threshold for unwanted class; and

a, b, c, d=Constants

Referring back to FIG. 3, the final score determination module 309, determines a final score 317 for each of the one or more surveillance feeds 318. The final score 317 is determined based on the corresponding importance score 316 and the one or more surveillance data 319. Based on the final score 317, the one or more surveillance feeds 318 are displayed. Here, the final score 317 determines the priority of the one or more surveillance feeds 318. Thereby, the one or more surveillance feeds 318 are displayed accordingly. For example, a surveillance feed 318 may be displayed for a longer time. Similarly, a surveillance feed 318 may be displayed on the entire screen masking the other surveillance feeds 318.

The surveillance unit 202 may also comprise other modules 310 to perform various miscellaneous functionalities. It will be appreciated that such aforementioned modules may be represented as a single module or a combination of different modules. Also, the other modules 310 may generate notifications and provide the notifications to the one or more alarm units 203 associated with the surveillance unit 202.

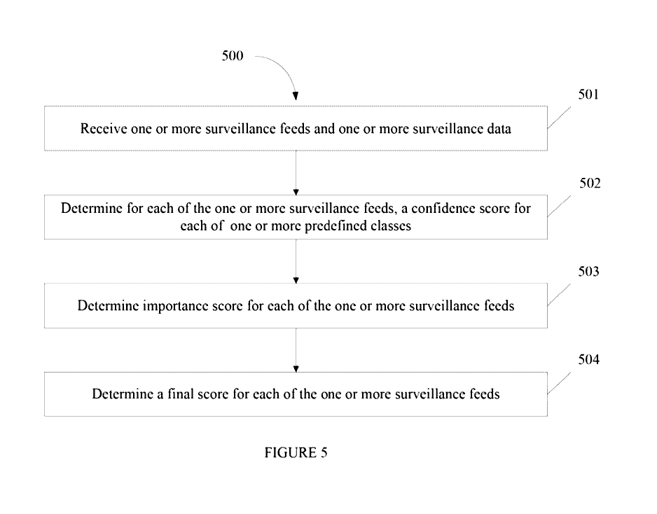

FIG. 5 shows a flowchart illustrating a method for dynamic display of surveillance feeds, in accordance with some embodiments of the present disclosure.

As illustrated in FIG. 5, the method 500 comprises one or more steps for dynamically displaying one or more surveillance feeds. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 501, receive one or more surveillance feeds and one or more surveillance data. The receiver module 306 of the surveillance unit 202 receives one or more surveillance feeds and one or more surveillance data from the one or more capturing devices 401. Further, the receiver module 306 convert each of the one or more surveillance feeds 318 into one or more image frames. Thereby, the receiver module 306 converts each of the one or more image frames into one or more feature vectors.

At step 502, determine for each of the one or more surveillance feeds 318, confidence score 315 for each of the one or more predefined classes. The classifier module 307 receives the one or more feature vectors and outputs a confidence score 315 for each of the one or more predefined classes corresponding to each of the one or more surveillance feeds 318. Here, each of the one or more predefined classes is grouped under one of one or more predefined categories. Further, the classifier module 307 makes use of HMM to categorize each of the one or more surveillance feeds 318 into one of one or more categories.

At step 503, determine importance score 316 for each of the one or more surveillance feeds 318. The importance score determination module 308, determines the importance score 316 for each of the one or more surveillance feeds 318. FIG. 4 shows an exemplary curve illustrating importance score 316 for each of the one or more categories.

At step 504, determine a final score 317 for each of the one or more surveillance feeds 318. The final score determination module 309 determines a final score 317 of each of the one or more surveillance feeds 318 based on the confidence score 315 of each of the one or more predefined classes and the one or more surveillance data 319. The display unit 302 dynamically displays the one or more surveillance feeds 318 based on the final score 317 of the one or more surveillance feeds 318. Further, the one or more alarm units 203 generates alarm if the final score 317 of at least one of the one or more surveillance feeds 318 exceed a predetermined threshold value.

In an exemplary embodiment, consider a surveillance system 200 with two cameras 201, each of the two cameras capturing one feed 318 in a bank. The user has predefined the categories as known wanted, known unwanted and unknown. Also, the user has predefined the classes, as a subject carrying a weapon, a subject changing course, a subject sitting, a subject talking and a subject walking straight. Each of the predefined classes is grouped under one of one or more predefined categories. A subject carrying a gun and a subject changing course may be grouped under known unwanted category, a subject talking, a subject sitting and a subject walking straight may be grouped under known wanted category. Activities other than the predefined activities may be grouped under unknown category. The one or more predefined categories and the respective one or more predefined classes are as shown in Table 1:

TABLE 1

| Class No | Class | Category |
|---|---|---|
| 1 | Subject sitting | Known Wanted |
| 2 | Subject talking | |
| 3 | Subject walking straight | |
| 4 | Subject with gun | Known Unwanted |
| 5 | Subject changing course | |
| | Any activity other than the | Unknown |
| | predefined activities | |

The surveillance unit 202 receives the two surveillance feeds 318 from the two cameras 201. Each of the two feeds 318 are converted into one or more image frames and then into one or more feature vectors by the receiver module 306. The classifier module 307 receives the one or more feature vectors from the receiver module 306. Further, the classifier module 307 determines the confidence score 315 for each of the five classes corresponding to each of the two feeds 318. This is illustrated as:

For Feed 1:

TABLE 2

| Class | 1 | 2 | 3 | 4 | 5 |
|---|---|---|---|---|---|
| Confidence Score | 0.70 | 0.01 | 0.25 | 0.01 | 0.03 |

For Feed 2:

TABLE 3

| Class | 1 | 2 | 3 | 4 | 5 |
|---|---|---|---|---|---|
| Confidence Score | 0.01 | 0.30 | 0.35 | 0.10 | 0.24 |

From Table 2, the confidence score 315 of 0.7 for class 1 illustrates that the surveillance unit 202 is somewhat confident that a subject is sitting, hence feed 1 may fail under known wanted category. Likewise, the confidence score 315 is calculated for each of the one or more classes and a weighted average determines to which class the surveillance feed 318 is closer to. Based on the weighted average of the confidence score 315, the surveillance feed 318 is categorized. Since the weighted average of the confidence score 315 for feed 1 is more probable to be closer to class 1, feed 1 may be classified as known wanted.

From Table 3, the feed 2 is equally probable to fall under any of the categories, since the confidence score 315 of each of the classes are nearly equal. Here, the classifier module 307 cannot make a definite decision and hence classifies feed 2 as unknown.

Further, an importance score 316 is determined by the importance score determination module 308 for each of the two surveillance feeds 318, based on the five confidence scores 315 for each of the five classes. Hence, two confidence score 315 is determined. Lastly, a final score 317 for each of the two feeds 318 is determined based on the two importance score 316 and the one or more surveillance data 319 given to the surveillance unit 202. Thereafter, the display unit 302 displays the two feeds 318 based on final score 317. Here, since feed two is categorized under unknown category, it is given more priority and displayed accordingly. Also, an alarm may be generated by the one or more alarm unit 203 to intimate the user monitoring the display.

Computer System

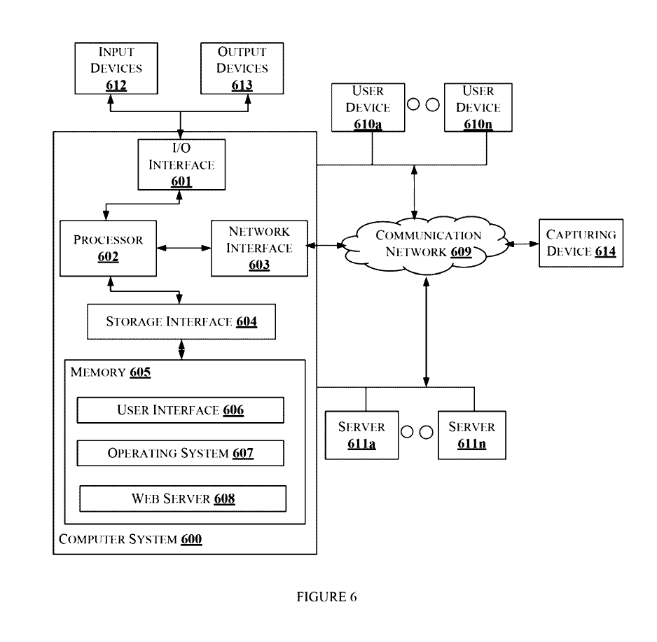

FIG. 6 illustrates a block diagram of an exemplary computer system 600 for implementing embodiments consistent with the present disclosure. In an embodiment, the computer system 600 is used to implement the method for dynamically displaying one or more surveillance feeds. The computer system 600 may comprise a central processing unit (“CPU” or “processor”) 602. The processor 602 may comprise at least one data processor for executing program components for dynamic resource allocation at run time. The processor 602 may include specialized processing units such as integrated system (bus) controllers, memory management control units, floating point units, graphics processing units, digital signal processing units, etc.

The processor 602 may be disposed in communication with one or more input/output (I/O) devices (not shown) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 600 is connected to the one or more user devices 611a, . . . ,611n, the one or more servers 610a, . . . ,610n and the camera 614 through a communication network 609 The processor 602 may be disposed in communication with the communication network 609 via a network interface 603. The network interface 603 may communicate with the communication network 609. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 609 may include, without limitation, a direct interconnection, local area network (LAN), wide area network (WAN), wireless network (e.g., using Wireless Application Protocol), the Internet, etc. Using the network interface 603 and the communication network 609, the computer system 600 may communicate with the one or more user devices 611a, . . . ,611n, the one or more servers 610a, . . . ,610n and the camera 616. The network interface 603 may employ connection protocols include, but not limited to, direct connect, Ethernet (e.g., twisted pair 10/100/1000 Base T), transmission control protocol/internet protocol (TCP/IP), token ring, IEEE 802.11a/big/nix, etc.

The communication network 609 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface 606, an operating system 607, web server 608 etc. In some embodiments, computer system 600 may store user/application data 606, such as the data, variables, records, etc. as described in this disclosure. Such databases may be implemented as fault-tolerant, relational, scalable, secure databases such as Oracle or Sybase.

The operating system 607 may facilitate resource management and operation of the computer system 600. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 600 may implement a web browser 607 stored program component. The web browser 608 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX, DHTML, Adobe Flash, JavaScript, Java, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 600 may implement a mail client stored program component. The mail client may be a mail viewing application, such as Apple Mail, Microsoft Entourage, Microsoft Outlook, Mozilla Thunderbird, etc.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of, FIG. 5, show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

### ADVANTAGES OF THE PRESENT INVENTION

In an embodiment, the present disclosure discloses a surveillance unit for dynamically displaying one or more surveillance feeds. In an exemplary embodiment, the present disclosure uses HMM algorithm to categorize and especially identify unknown activities and unknown. With the unknown category identified, the present disclosure helps in carrying out surveillance more efficiently.

In an embodiment, the present disclosure discloses a surveillance system for dynamically displaying the one or more surveillance feeds. The display and alarm unit of the surveillance system dynamically displays the one or more surveillance feeds based on the final score determined. Certain feeds carry priority and such feeds are displayed accordingly, thus attending the important feeds. This reduces the number of screens, since the feeds can be displayed in less number screens based on priority.

In an embodiment, the display and alarm unit generates an alarm to notify a user monitoring the display. This helps in reducing human errors and increases the efficiency of monitoring and increases the alertness of security personnel.

In an embodiment of the present disclosure, the intelligence gathering is improved by using the modified algorithm to identify activities using capturing devices.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference number | Description |
|---|---|
| Surveillance system | 200 |
| Capturing units | 201 |
| Surveillance unit | 202 |
| Alarm units | 203 |
| Processor | 301 |
| Display unit | 302 |
| I/O Interface | 303 |
| Memory | 304 |
| Modules | 305 |
| Receiver module | 306 |
| Classifier module | 307 |
| Importance score determination module | 308 |
| Final score determination module | 309 |
| Other Module | 310 |
| Data | 311 |
| Importance of field of view | 312 |
| Volume of traffic | 313 |
| Time of interest | 314 |
| Confidence score | 315 |
| Importance score | 316 |
| Final score | 317 |
| Surveillance feeds | 318 |
| Surveillance data | 319 |
| Other data | 320 |
| General computer system | 600 |
| I/O Interface | 601 |
| Processor | 602 |
| Network Interface | 603 |
| Storage Interface | 604 |
| Memory | 605 |
| User Interface | 606 |
| Operating System | 607 |
| Web Server | 608 |
| Communication Network | 609 |
| User Device | 610a, 610n |
| Server | 611a, 611n |
| Input Device | 612 |
| Output Device | 613 |
| Capturing Device | 614 |

We claim:

1. A method for dynamic display of surveillance feeds, comprising:
receiving, by a surveillance unit, one or more surveillance feeds and one or more surveillance data;
determining, by the surveillance unit, for each of the one or more surveillance feeds, a confidence score for each of one or more predefined classes, wherein each of the one or more predefined classes are grouped under one of one or more predefined categories;
determining, by the surveillance unit, importance score for each of the one or more surveillance feeds based on the confidence score of each of the one or more predefined classes of the corresponding one or more surveillance feeds; and
determining, by the surveillance unit, a final score for each of the surveillance feeds based on the corresponding importance score and the one or more surveillance data, wherein the one or more surveillance feeds are dynamically displayed based on the final score of each of the surveillance feeds.

2. The method as claimed in claim 1, wherein the one or more surveillance data are at least one of importance of field of view of one or more capturing units associated with the surveillance unit, volume of traffic of one or more subjects and time of interest.

3. The method as claimed in claim 2, wherein the time of interest is time of a day and day of a week.

4. The method as claimed in claim 1, wherein the one or more predefined categories comprise at least one of known wanted activity, known unwanted activity and unknown activity.

5. The method as claimed in claim 1, wherein the confidence score of each of the one or more predefined classes is determined based on activities of one or more subjects in the one or more surveillance feeds.

6. The method as claimed in claim 1 further comprising generating an alarm, when the final score of each of the one or more surveillance feeds exceeds a predetermined threshold value.

7. A surveillance unit for dynamic display of surveillance feeds, comprising:
a processor; and subject
a memory communicatively coupled to the processor, wherein the memory stores processor-executable instructions, which, on execution, causes the processor to:
receive one or more surveillance feeds and one or more surveillance data;
determine for each of the one or more surveillance feeds, a confidence score for each of one or more predefined classes, wherein each of the one or more predefined classes are grouped under one of one or more predefined categories;
determine importance score for each of the one or more surveillance feeds, based on the confidence score of each of the one or more predefined classes of the corresponding one or more surveillance feeds; and
determine a final score for each of the one or more surveillance feeds, based on the corresponding importance score and the one or more surveillance data, wherein the one or more surveillance feeds are dynamically displayed based on the final score of each of the surveillance feeds.

8. The surveillance unit as claimed in claim 7, wherein the one or more surveillance data are at least one of importance of field of view of one or more capturing units associated with the surveillance unit, volume of traffic of the one or more subjects and time of interest.

9. The surveillance unit as claimed in claim 8, wherein the time of interest is the time of day and day of week.

10. The surveillance unit as claimed in claim 7, wherein the one or more predefined categories comprise at least one of, known wanted behaviour, known unwanted behaviour and unknown behaviour.

11. The surveillance unit as claimed in claim 7, wherein the confidence score of each of the one or more predefined classes is determined based on activities of one or more subjects in the one or more surveillance feeds.

12. The surveillance unit as claimed in claim 7, further comprising an alarm to generate a notification, if the final score of each of the one or more surveillance feeds exceeds a predetermined threshold value.

13. A surveillance system for dynamic display of surveillance feeds, comprising:
one or more capturing units to capture the one or more surveillance feeds of the one or more subjects;
a processor; and
a memory communicatively coupled to the processor, wherein the memory stores processor-executable instructions, which, on execution, causes the processor to:
receive the one or more surveillance feeds and one or more surveillance data;
determine for each of the surveillance feeds, a confidence score for each of one or more predefined classes, wherein each of the one or more predefined classes are grouped under one of one or more predefined categories;
determine importance score for each of the one or more surveillance feeds, based on the confidence score of each of the one or more predefined classes of the corresponding one or more surveillance feeds; and
determine a final score for each of the one or more surveillance feeds, based on the corresponding importance score and the one or more surveillance data, wherein the one or more surveillance feeds are dynamically displayed based on the final score of each of the one or more surveillance feeds; and
one or more alarm units to generate an alarm based on the final score.
